(19) United States
(12) Patent Application Publication
(10) Pub. No.: US 2007/0261528 A1
(43) Pub. Date: Nov. 15, 2007

(54) Unit Cutting Dough Surface in Equal Depth

(75) Inventor: Selahattin Dinler, Istanbul (TR)

Correspondence Address: KILYK & BOWERSOX, P.L.L.C., 3603 CHAIN BRIDGE ROAD, SUITE E, FAIRFAX, VA, 22030, US

(73) Assignee: Sarmasik Makine Sanayi ve Ticaret A.S., Istanbul (TR)

(21) Appl. No.: 10/578,754

(22) PCT Filed: Nov. 6, 2003
(86) PCT No.: PCT/TR03/00084

§ 371 Date: Mar. 29, 2007

(51) Int. Cl. A21C 11/12

(52) U.S. Cl. 83/508.2

(57) ABSTRACT

The movement of the cutting knife (1) in the unit used for bread production in bread manufacture industry is controlled in three axes. After, the product has been carried to the cutting line along the third axis, the cutting knife group is moved by means of the trigger belt (8) triggered with a reducer (7) in the product cutting direction along the second axis. During this movement, the product surface profile reference information is identified with a laser sensor (4), the height of the cutting knife is moved with the encoder and servo motor (6) along the first axis in accordance with the aforementioned reference information. As a result, the product surface is cut with the cutting knife at a desired depth (B) in consideration with the profile and height of the product.

This invention pertains to the unit which performs the cutting operation of the product surface with a knife automatically at a certain desired depth based on the upper surface profiles of the bread doughs.

Prior to this invention, the cutting operation of bread doughs was performed manually one by one. In the sample models of this unit developed subsequently, a circular saw or a knife triggered with a motor is used as a cutting knife and the movement of the parts on the product is realized not as per the upper surface profile of the products, but on a linear basis at a certain distance [Illustration ¼ (A)] in parallel with the lower ground. In this invention, on the other hand, as the cutting movement is realized with reference to the upper surface profile of the product, the cutting depth [Illustration ¼ (B)] always remains at the same depth according to the upper surface profile of the product.

For the operation of this unit, the products are preferably lined on a band which is triggered by a reducer. The products on the band are brought to the cutting position determined with a driver-motor driving system on a time basis. In the aftermath, the cutting knife group is moved in the cutting direction by means of the trigger belt (8) triggered with reducer [Illustration 2/4 and ¾] (7) on the rail where it is bedded. During this movement, the product surface profile reference information is perceived with a laser sensor (4) placed within the system. Here, the position adjustment of the laser sensor is performed with a mechanism controlled in three different axles (3). In order to follow this reference information, the cutting knife group is moved with a servo motor (6) in the cutting depth direction. The information as to the quantity of movement is perceived via an encoder in the motor shaft. Due to an enclosed cycle, the cutting operation is performed so as to allow the cutting depth to be at equal distances to the upper surface profile of the dough on an automatic basis.

One or two cutting blades (1) may be available on the cutting knife group. The cutting knife group in the single cutting knife system performs its movement in a single cutting direction.

In double cutting knife system, on the other hand, the cutting knife group is moved in both cutting directions automatically. But, each cutting knife performs the cutting operation in only one direction. The positions of the cutting knives are changed with a pneumatic piston (5). When the cutting knife group completes its movement in cutting direction in one period, the position of the cutting knife enters into the water in a container (9) at the time of its change with a pneumatic piston. During the course of the movement, the cutting group continues its movement in the other period and finally comes to the point where the second water container is placed. Here, the connection of the cutting knives is performed with a mechanism (2) which can be easily dismounted and mounted without need for any adjustment.

An additional cutting knife mechanism can be incorporated in this unit as a 4^{th} axis, optionally, and a single or multiple cutting operation can be obtained in length or breadth on the manufacture.

This unit can be easily used in the companies which make mass production in bread manufacture sector. Following the resting operation of the bread doughs, the cutting operation carried out on the doughs is thus performed as per the intended direction rapidly with the mounting of this unit on the band system.

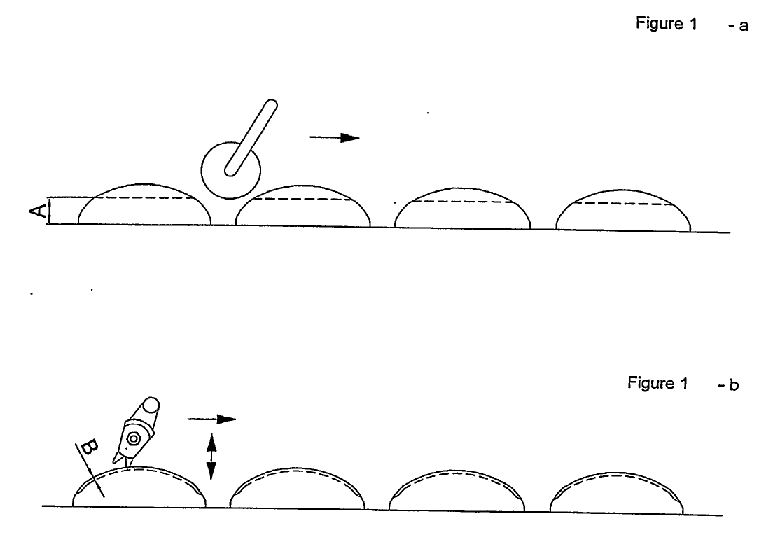

The line of the knife at previous art is mentioned in FIG. 1/4(a) and the line of the knife in this system is mentioned in the FIG. 1/4(b).

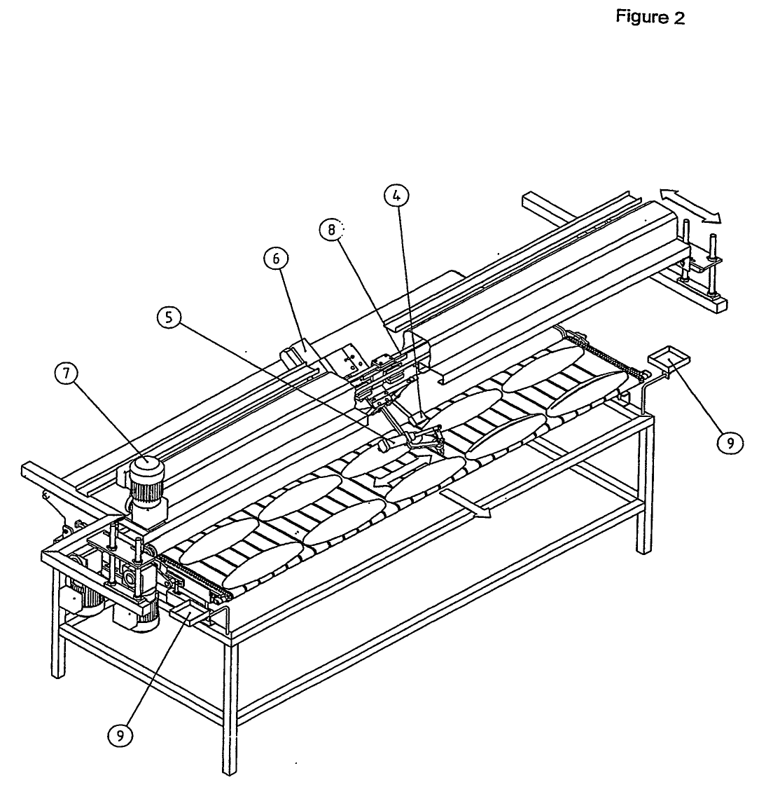

The left side perspective general view of the unit that cuts in equal depth of dough surface is given in the FIG. 2/4.

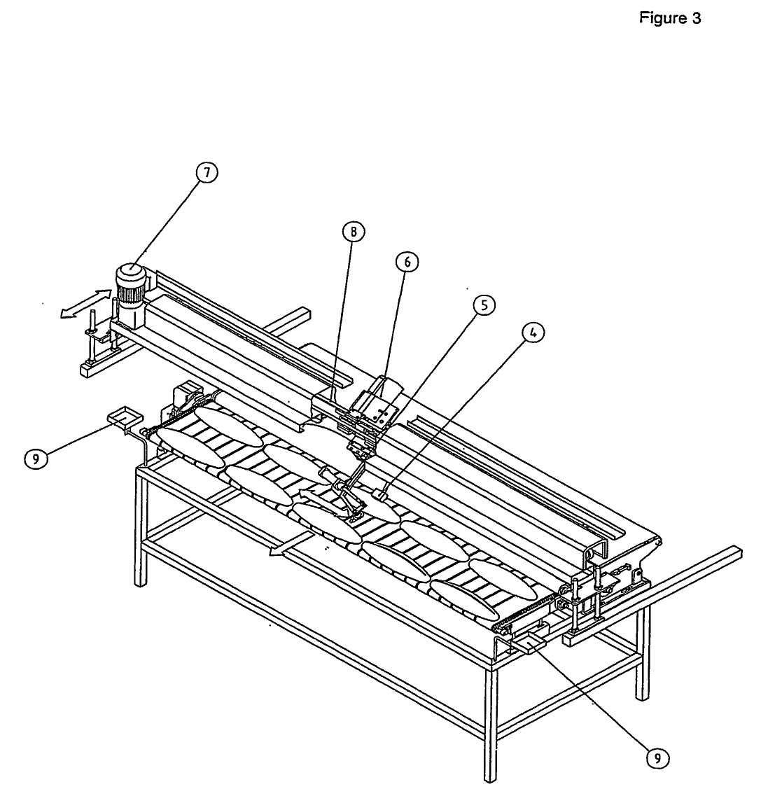

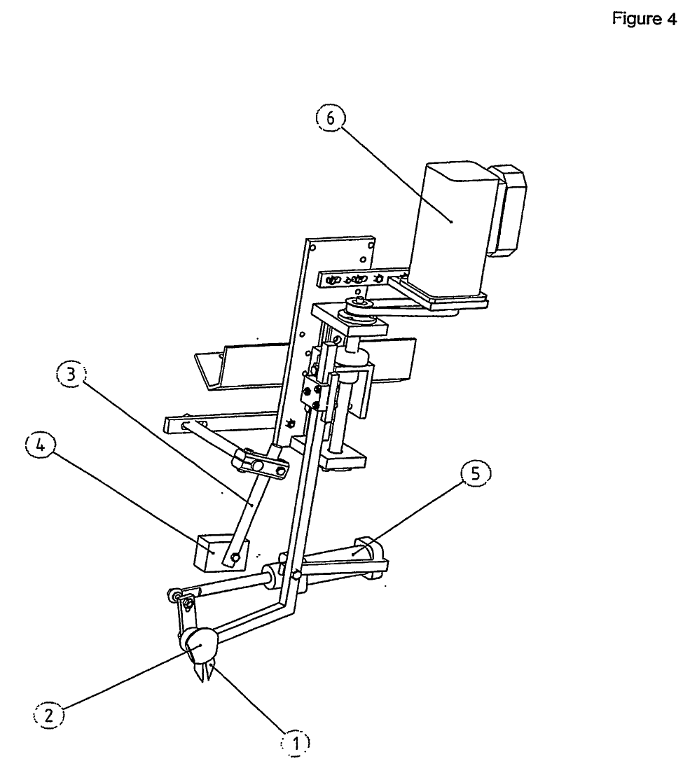

The right side perspective general view of the unit that cuts in equal depth of the dough surface is given in FIG. 3/4. The intelligent blading system rear view is given in FIG. 4/4.

1. It is the unit which cuts the surface of the bread dough at an equal depth, and the characteristics of this unit is that the dough upper surface profile information taken with laser sensor connected with a mechanism where the position adjustment can be made easily in three axles is followed with an electronic enclosed cycle system, and that the movement of the cutting knife group in the cutting depth direction is moved with an encoder—servo motor control.

2. The cutting knife connection in claim 1 is made with a mechanism which can be easily dismounted and mounted without need for any adjustment.

3. The cutting knife in claim 1 is immersed into water within a container at the end of each period and its position is changed with a pneumatic piston for the next period.

4. With the incorporation of an optional cutting knife mechanism for the 4^{th} axis, a single or multiple cutting operation can be obtained in length or breadth on the manufacture.
